(19) United States
(12) Patent Application Publication
(10) Pub. No.: US 2011/0033596 A1
(43) Pub. Date: Feb. 10, 2011

(54) REDUCED CALORIE SWEETENERS AND CONSUMABLE ITEMS

(76) Inventors: Gino Olcese, Allen, TX (US); Sarah Erdman, McKinney, TX (US)

Correspondence Address: COX SMITH MATTHEWS INCORPORATED, 112 EAST PECAN STREET, SUITE 1800, SAN ANTONIO, TX, 78205-1521, US

(21) Appl. No.: 12/537,402

(22) Filed: Aug. 7, 2009

(51) Int. Cl. A23L 2/60

(52) U.S. Cl. 426/548; 426/590

(57) ABSTRACT

Reduced calorie consumable items and sweeteners that may be used in producing those items are described. Those reduced calorie consumable items have taste characteristics similar to those of full calorie items. Such reduced calorie consumables may include a combination of sweeteners that provides a taste similar to natural sugars and alleviates many of the negative attributes commonly associated with other reduced calorie consumables. The sweetener combination may include the high potency sweeteners aspartame and acesulfame potassium used with one or more natural sweeteners. Natural sweeteners may include fructose and an extract derived from plants of the species Stevia rebaudiana Bertoni, substantially purified in the component rebaudioside A.

### FIELD

The present application relates to reduced calorie sweeteners, which, for example, can be used in foods, beverages, and pharmaceutical applications, that have taste characteristics similar to those of full calorie sweeteners.

### BACKGROUND

A number of health concerns have been correlated with high calorie diets and obesity. In light of this, many consumers are attempting to reduce their calorie intake, and interest in consumable items with low calorie content is considerable. It has, however, been difficult to produce low calorie consumable items that also have desired taste, including, for example, adequate sweetness. Full calorie consumable items are commonly sweetened with natural sugars such as sucrose. The use of natural sugars provides a desired level of sweetness and may influence additional traits related to overall appeal of those consumable items. Natural sugars also provide syrup-like consistency, a trait that contributes to the overall smoothness and mouthfeel of a consumable item.

High potency sweeteners are commonly used in lower calorie content consumable items as a substitute for natural sugars. Such high potency sweeteners may provide substantial sweetness in a consumable item without imparting a significant caloric contribution. High potency sweeteners may intensely activate sweetness receptors within the mouth even at low concentrations, and therefore can be used at significantly lower amounts than natural sugars. Additionally, some high potency sweeteners may not be effectively metabolized in energy-providing reactions within the body and therefore may not contribute to the caloric content of a consumable item. Unfortunately, according to many consumers, high potency sweeteners do not impart exactly the same taste as natural sugars, and such consumers may experience negative taste characteristics of consumable items that include those sweeteners. Negative attributes associated with such consumable items include but are not limited to a lack of upfront sweetness, lingering sweetness, and a lack of overall flavor. Additionally, the general mouthfeel of reduced calorie consumable items may suffer in the absence of the syrup-like feel or texture that is associated with sugars. Deficiencies in sweetness and consumable item texture may also influence aftertaste and off-taste characteristics that may be associated with high potency sweeteners. In light of the foregoing, it would be beneficial to provide reduced calorie consumable items that avoid or suppress the negative characteristics associated with high potency sweeteners which are commonly found in consumable items sweetened by means other than natural sugars.

### SUMMARY

The reduced calorie consumable items described herein may have taste characteristics similar to those of full calorie items. Such reduced calorie consumable items may include a combination of sweeteners that provides a taste similar to natural sugars and alleviates many of the negative attributes commonly associated with other reduced calorie consumable items. In some embodiments, the sweetener combination may include the high potency sweeteners aspartame and acesulfame potassium used with one or more natural sweeteners. Natural sweeteners may include, for example, fructose and an extract derived from plants of the species Stevia rebaudiana Bertoni, which may be substantially purified in the component rebaudioside A. Some embodiments of reduced calorie consumable items may include sweeteners that stimulate receptors throughout the oral cavity and provide a smooth and balanced mouthfeel which closely resembles that of natural sugar. Such reduced calorie consumable items may provide an effective level of upfront sweetness that does not linger after sampling is complete. In some embodiments of reduced calorie consumable items, the sweetness may be substantially similar to natural sugars and may help suppress negative characteristics commonly associated with other low calorie consumable items, including lacking overall flavor, having limited or improper mouthfeel, or having off-taste properties such as a bitter, metallic or licorice-like aftertaste.

### BRIEF DESCRIPTION OF THE FIGURES

FIG. 1 is a graph showing the overall acceptance of various samples. The characteristic was evaluated by a trained sensory panel and is shown on a 9-point scale where higher values correspond with an improved overall acceptance.

FIG. 2 is a graph showing the overall flavor of various samples. The characteristic was evaluated by a trained sensory panel and is shown on a 9-point scale where higher values correspond with an improved overall flavor.

FIG. 3 is a graph showing the sweetness of various samples. The characteristic was evaluated by a trained sensory panel and is shown on a 9-point scale where higher values correspond with an improved sweetness.

FIG. 4 is a graph showing the smoothness of various samples. The characteristic was evaluated by a trained sensory panel and is shown on a 9-point scale where higher values correspond with an improved smoothness.

FIG. 5 is a graph showing the aftertaste of various samples. The characteristic was evaluated by a trained sensory panel and is shown on a 9-point scale where higher values correspond with a diminished aftertaste.

FIG. 6 is a graph showing the quality of aftertaste of various samples. The characteristic was evaluated by a trained sensory panel and is shown on a 9-point scale where higher values correspond with an improved aftertaste quality.

FIG. 7 is a table of data indicating various characteristics of various samples including overall aroma, overall flavor, sweetness, tartness, and mouthfeel.

FIG. 8 is a table of data indicating various characteristics of additional samples including overall aroma, overall flavor, sweetness, tartness, and mouthfeel.

### DETAILED DESCRIPTION

The following terms as used herein should be understood to have the indicated meanings.

When an item is introduced by “a” or “an,” it should be understood to mean one or more of that item.

“Comprises” means includes but is not limited to.

“Comprising” means including but not limited to.

“Having” means including but not limited to.

The term “beverage” as used herein means any drinkable liquid or semi-liquid, including for example flavored water, soft drinks, fruit drinks, coffee-based drinks, tea-based drinks, juice-based drinks, milk-based drinks, gel drinks, carbonated or non-carbonated drinks, alcoholic or non-alcoholic drinks.

The term “consumable item” means anything that may be orally ingested by a consumer, including without limitation a food, beverage, pharmaceutical composition, nutraceutical composition, vitamin, lozenge, dietary supplement, confection, chewing gum, candy and a combination of any of the foregoing.

The term “high potency sweetener” means any ingredient that initiates a perception of sweetness at a concentration less than that which would be required for a natural sugar.

The term “intensity of a sweetener” means the rate of change of a sweetness level as the concentration of the sweetener is changed.

The term “oral cavity” means any region of the mouth or throat that may be stimulated by a consumable item and contribute to a perception of overall taste of the consumable item.

The term “powder” means a particulate solid with any size distribution of particles. A powder may be crystalline, polycrystalline, amorphous or any other solid phase of particulate matter.

The term “reduced calorie beverage” as used herein means any beverage that provides less than about 10 Kilocalories of energy per fluid ounce. A typical serving size is about 8 to 12 fluid ounces of the beverage, but any serving size may be used.

The term “full calorie beverage” as used herein means any beverage that provides at least about 11 Kilocalories of energy per fluid ounce. A typical serving size is about 8 to 12 fluid ounces of the beverage, but any serving size may be used.

The term “stevia extract” means a semi-purified material derived from a plant of the species Stevia rebaudiana Bertoni that contains greater than about a 95% proportion of the component Rebaudioside-A.

This disclosure is directed to reduced calorie sweeteners and consumable items that have taste characteristics similar to those exhibited by full calorie consumables. Such reduced calorie sweeteners and consumable items may include a combination of high potency sweeteners and one or more natural sweeteners. Improvements in taste for the reduced calorie consumable items described in this disclosure, including increasing the similarity of their taste to full calorie consumables, may in some embodiments be related to the suppression of at least one negative characteristic commonly associated with other consumables designed with lower calorie content than full calorie consumables. By way of non-limiting example, some negative characteristics commonly associated with other lower calorie content consumable items may include inadequate overall sweetness, excessive overall sweetness, lacking upfront sweetness, lingering sweetness, lacking overall flavor, having limited or improper mouthfeel, having off-taste properties such as bitter, metallic or licorice-like aftertaste, and combinations of the foregoing.

Sweeteners included in a consumable item may influence the above mentioned negative characteristics in various ways. Sweeteners included in a consumable item may be used in controlled amounts and proportions in order to optimize the taste characteristics of a consumable. The influence of sweeteners on negative characteristics may be directly attributed to stimulation of sweetness receptors in the oral cavity, such as is the case, for example, in inadequate overall sweetness or lacking upfront sweetness, or may be related to the sweeteners indirectly, such as may be the case for negative characteristics including, for example, improper mouthfeel, lacking overall flavor, or having off-taste properties. In general, the sweetness properties associated with natural sugars are most appealing, and attempts may be made in some embodiments of reduced calorie consumable items to match the properties of natural sugars. A description of the properties of natural sugar or of a sweetener in general may include the sweetness level which characterizes the magnitude in which a consumer perceives the property of sweetness. A description of a sweetener may also include how the perception of sweetness varies as a function of time, including sweetness perception immediately after sampling a consumable item and at other time points following consumption. A description of a sweetener may also include the level of sweetness perceived for the entire oral cavity or with different values in individual regions of the oral cavity. In addition to providing adequate levels of the perception of sweetness, sweetener combinations described herein may be made that match the time dependence of natural sugars, the spatial dependence of natural sugars, or both. As further described herein, sweeteners that match the sweetness level, time dependence, or spatial dependence of natural sugar, at the concentration of a full calorie consumable item, may suppress negative characteristics commonly associated with consumable items of lower calorie content.

In some embodiments of reduced calorie consumable items described herein, the sweeteners used may include combinations of high potency sweeteners and one or more natural sweeteners. The one or more natural sweeteners described may in some embodiments be included at concentrations that by themselves are insufficient to achieve an acceptable level of sweetness. Similarly, the combination of high potency sweeteners used may in some embodiments be included at concentrations that by themselves are insufficient to achieve an acceptable level of sweetness. The combination of high potency sweeteners and the one or more natural sweeteners may, however, be sufficient to provide adequate sweetness in a consumable item. In some embodiments, the overall sweetness level provided by the sweeteners may be greater than would be expected by simply adding the combination of high potency sweeteners and the one or more natural sweeteners. In those embodiments, the combination of sweeteners may provide non-linearity in the overall sweetness level that is perceived.

When used at concentrations commonly found in full calorie consumable items, natural sugars may provide a high level of sweetness. In this respect, one may differentiate the level of sweetness that may be achieved with a sweetener from the intensity of the sweetener. In comparison to natural sugars, some high potency sweeteners may show a more rapid increase in sweetness with increasing concentration in ranges where the sweetener is used in relatively low amounts. This behavior may not hold at higher concentrations, and the maximum sweetness level that may be achieved with high potency sweeteners may not be as high as that of natural sugar. In some embodiments, a combination of sweeteners may be used in a reduced calorie consumable item that provides a level of sweetness comparable to that of a full calorie consumable item but providing significantly lower calorie content.

The sweetness of a consumable item as provided by one or more sweeteners may be further described as having a value that changes with time. In comparison to most high potency sweeteners, natural sugars may be described as providing a perception of sweetness that increases rapidly following consumption. This increase in the level of sweetness may be followed by a relatively rapid decline. The level of sweetness provided by one or more sweeteners as a function of time may in general be referred to as the sweetness temporal profile. In some embodiments, a combination of sweeteners may be used that provides a sweetness temporal profile that more closely matches that of natural sugar and may provide a consumable item with improved taste and the suppression of at least one negative characteristic. A consumable item with a sweetness temporal profile that is significantly different than natural sugars may have a number of negative characteristics, including but not limited to lacking upfront sweetness and having lingering sweetness. In either of those situations, wherein sweetness is delivered too fast or too slow, the overall customer ranking of sweetness may be negatively impacted. Additional characteristics that may be modified by how closely sweeteners match the temporal profile of natural sugars include mouthfeel, smoothness, balance of sweetness to tartness, and in some cases off-taste components. Those characteristics may furthermore impact the overall flavor of the consumable item.

A description of the sweetness provided by one or more sweeteners may also include the sweetness perceived at different spatial locations within the oral cavity. The level of sweetness provided by one or more sweeteners at different locations in the oral cavity may in general be referred to as the sweetness spatial profile. Natural sugars are commonly described as providing sweetness that is balanced within the oral cavity. The balanced feel associated with natural sugars may at least in part be attributed to the property of delocalization of sweetness throughout the oral cavity. In contrast, high potency sweeteners may provide a sensation of localized sweetness. Localized sweetness may be perceived by the consumer as artificial, and may not be well accepted by a number of consumers. Delocalization of sweetness perception is a property wherein receptors throughout the oral cavity are stimulated in a relatively uniform manner. A consumable item that provides sweetness that has a spatial profile similar to natural sugar may be described as having the property of delocalization of sweetness perception. Delocalization of sweetness perception is an attribute that frequently drives customer acceptance and may suppress negative characteristics of a consumable. In some embodiments of reduced calorie consumable items, a combination of sweeteners may be used that provides a sweetness spatial profile that more closely matches that of natural sugar and provides delocalization of sweetness perception. Characteristics that may be modified by delocalization of sweetness perception include but are not limited to sweetness, smoothness, flavor and mouthfeel.

High potency sweeteners currently used in the food and beverage industry do not perfectly match the aforementioned properties of natural sugars. The use of high potency sweeteners therefore may initiate some of the above mentioned deficiencies. High potency sweeteners may, for example, stimulate sweetness receptors in the mouth but may do so more slowly than natural sugars. This frequently results in the perception of a delayed response, or lack of upfront sweetness. Additionally, many high potency sweeteners that stimulate sweetness receptors more slowly than natural sugars also cause a response that may be present for an extended period of time. Lingering sweetness is an undesirable characteristic that may result in poor customer acceptance of a sweetener. The difference in temporal characteristics between high potency sweeteners and natural sugars may result in a perceived sweetness that is less than ideal. The temporal dynamics of sweetness may influence additional characteristics including but not limited to the delivery of flavor provided by a consumable item.

Combinations of high potency sweeteners may be used that adjust the sweetness temporal profile to more closely approximate that of natural sugar. Such combinations of high potency sweeteners may attempt to more closely match the temporal profile of natural sugars, and doing so may result in an overall sweetness temporal profile that contributes to consumable item acceptance. Unfortunately, such high potency sweeteners may preferentially stimulate spatial regions of the mouth in a manner slightly different from that of natural sugars, and the use of those high potency sweeteners may present localized sweetness that contributes additional concerns for other characteristics. As described above, sweetness imbalance between different regions of the mouth may contribute to a lack of mouthfeel and result in an overall smoothness and flavor that is less than ideal. It should be noted that a combination of sweeteners, each of which matches either the temporal profile or the spatial profile of natural sugar individually, may not necessarily match those two profiles simultaneously. It is difficult to create a blend from high potency sweeteners that has both ideal mouthfeel and smoothness while also providing effective delivery of flavor and providing upfront sweetness while also avoiding lingering sweetness. Combinations of high potency sweeteners without a natural sweetener as described herein may not be able to simultaneously match both of those profiles. In some embodiments, sweeteners for a reduced calorie consumable item are provided that simultaneously optimize both the spatial profile and the temporal profile of sweetness.

In some embodiments, the one or more natural sweeteners may be present at levels significantly lower than that typically found in a full calorie consumable item. Natural sweeteners that may be added include but are not limited to fructose, stevia extract, and combinations thereof. Additional high potency sweeteners may be added that in combination with these natural sweeteners provide a desired level of sweetness. In some embodiments, for example, fructose may be added to a reduced calorie consumable item and may be present at a concentration between about 1,000 ppm to about 10,000 ppm. At the low concentration range of those embodiments, this level of fructose corresponds to slightly greater than 1 Kilocalorie for a 12 fluid ounce beverage sample. This level of fructose may be, for some embodiments, a minimum value necessary to suppress some negative characteristics of a lower calorie content consumable item. In other embodiments, natural sweeteners may be added to a reduced calorie consumable item at levels from about 1,000 ppm to about 92,000 ppm. The use of reduced calorie consumable items in some embodiments that contain relatively higher calorie contents may be beneficial for individuals who desire at least some source of energy from consumption but do not desire the calorie contribution of a full calorie consumable. At the high concentration range of those embodiments, this level of fructose may correspond to about 120 Kilocalories for a 12 fluid ounce beverage sample.

A number of different materials may be obtained from Stevia rebaudiana Bertoni, and these may include various different sweet tasting ingredients. These include, for example, a number of diterpene based molecules that may be classified as steviol glycosides. Steviol glycosides that may be obtained from species of Stevia rebaudiana Bertoni include stevioside, and at least several related rebaudiosides, including Rebaudioside-A described herein. Of all those steviol glycosides, Rebaudioside-A is thought to be the sweetest; The various sweet components that may be isolated from species of Stevia rebaudiana Bertoni may have slightly different properties, including but not limited to off-taste characteristics and sweetness temporal profiles that may modify the properties of a beverage. As such, depending upon the purity of materials derived from this species, off-taste characteristics or other properties that are at least in part modified by sweetness may limit the acceptable concentration range of stevia extract that may be used. The stevia extracts described herein may in some embodiments, for example, be added to a reduced calorie consumable item at a concentration of about 10 to about 150 ppm. In other embodiments, for example, stevia extract may be added to a reduced calorie consumable item at a concentration of about 20 ppm to about 120 ppm.

High potency sweeteners used in some embodiments may include a combination of acesulfame potassium and aspartame. These high potency sweeteners may have somewhat different characteristics including but not limited to different sweetness temporal profiles. As described above, the sweetness temporal profile may influence the characteristics of consumable items including but not limited to the magnitude or quality of aftertaste or other off-taste components of a consumable. Those characteristics may, in some embodiments, limit the acceptable concentration range or ratio of high potency sweeteners that may be used. In some embodiments, aspartame may be added at a concentration from about 1 to about 400 ppm. In other embodiments, aspartame may be added at a concentration from about 100 to about 260 ppm. In some embodiments, acesulfame potassium may be added to a reduced calorie beverage at a concentration from about 1 to about 120 ppm. In other embodiments, acesulfame potassium may be added at a concentration from about 50 to about 90 ppm. The ratio of aspartame to acesulfame potassium may, in some embodiments, be maintained between about 3 to about 5.

In some embodiments, a combination of high potency sweeteners and one or more natural sweeteners may be added individually to a consumable item. In other embodiments, all of the sweetener ingredients or a combination of some of the sweetener ingredients may be pre-mixed prior to addition to a consumable item. The ingredients in those pre-mixed combinations may be in various ratios, such as may be used to produce a consumable item with any ratio described in this disclosure. For example and without limitation, a pre-mix combination of aspartame and acesulfame potassium may be made by addition of between about 3 parts to about 5 parts by mass of aspartame to each part of acesulfame potassium. In some embodiments, combining the ingredients of a sweetener in a pre-mixed form may be by addition of various portions by mass of powders of individual ingredients. In other embodiments, one or more of the ingredients may be added as a solid, liquid or any other suitable medium. Similarly, the pre-mixed sweetener combination as a whole may be a powder, solid, liquid or any other suitable medium. Such a pre-mixed combination of ingredients may be sold or distributed in various forms including but not limited to individual sweetener packets, including those in sizes convenient for a consumer to add to individual servings of a consumable item, but any desirable size may be used. A pre-mixed sweetener may also be distributed in larger packages such that it may be added to batch-type manufacturing processes for consumable items. In some embodiments, a sweetener may be made by combining aspartame at a ratio of about 0.8 to about 8 parts by mass to each part of acesulfame potassium. In some embodiments, such a sweetener having aspartame and acesulfame potassium may also include fructose, wherein the aspartame:fructose ratio comprises aspartame at a ratio of about 0.001 to about 0.4 parts by mass to each part of fructose. In some embodiments, such a sweetener having aspartame and acesulfame potassium may also include stevia extract, wherein the aspartame:stevia extract ratio comprises aspartame at a ratio of about 0.67 to about 4 parts by mass to each part of stevia extract.

### EXAMPLES AND EXPERIMENTS

To test various embodiments of reduced calorie consumables items, a series of samples was made. Beverage samples were made by combining ingredients with water to produce a liquid with the specified concentrations indicated in Table 1. Water used in the beverages was specifically purified prior to use using processes well-known in the art such as filtration, deionization, distillation, or reverse osmosis.

TABLE 1
Beverage Samples Tested

| | Beverage | | Stevia | Aspar- | Acesul- |
|---|---|---|---|---|---|
| Beverage | Kilo- | Fructose | Extract | tame | fame-K |
| Sample | calories | (ppm) | (ppm) | (ppm) | (ppm) |
| DP 3 | 10 | 5 × 10³ | 0 | 252 | 60 |
| DP 4 | 10 | 5 × 10³ | 0 | 189 | 45 |
| DP 5 | 10 | 5 × 10³ | 0 | 220 | 52 |
| DP 7 | 10 | 5 × 10³ | 0 | 189 | 45 |
| DP 8 | 10 | 5 × 10³ | 0 | 220 | 52 |
| DP 9 | 10 | 5 × 10³ | 0 | 252 | 60 |
| DP 12 | 10 | 5 × 10³ | 0 | 252 | 60 |
| DP 13 | 10 | 5 × 10³ | 25 | 189 | 45 |
| DP 14 | 10 | 5 × 10³ | 25 | 220 | 52 |
| DP 15 | 10 | 5 × 10³ | 25 | 252 | 60 |
| DP 18 | 10 | 5 × 10³ | 25 | 252 | 60 |
| DP 20 | 10 | 5 × 10³ | 25 | 220 | 52 |
| DP 22 | 10 | 5 × 10³ | 25 | 189 | 45 |
| DP 23 | 10 | 5 × 10³ | 25 | 220 | 52 |
| DP 24 | 10 | 5 × 10³ | 25 | 252 | 60 |
| DP 25 | 0 | 0 | 0 | 252 | 60 |
| DP 26 | 10 | 0 | 25 | 252 | 60 |
| DP 27 | 0 | 0 | 0 | 515 | 0 |
| DS 24 | 150 | HFCS Added | 0 | 0 | 0 |
| DS 8 | 100 | HFCS Added | 90 | 0 | 0 |
| DS 12 | 100 | HFCS Added | 100 | 0 | 0 |

Beverage samples shown in Table 1 were typically made to a volume of 12 fluid ounces although, of course, other volumes may be used. Carbonated beverages were used unless otherwise specified. In other embodiments, beverages may be made that are not carbonated. Sample DP 27 was a reference sample that was made substantially the same as current carbonated diet beverages used in the industry. Sample DS 24 was a reference sample that was made substantially the same as carbonated full calorie beverages used in the industry. The full calorie beverage reference sample DS 24 was sweetened with high fructose corn syrup (HFCS), at a level sufficient to provide about 150 Kilocalories for the 12 fluid ounce sample. Samples DS 8 and DS 12 were sweetened using HFCS with an amount sufficient to provide about 100 Kilocalories of energy for the 12 fluid ounce sample.

Additional natural flavors and colors may be added in some embodiments, and natural flavors and colors were added to the beverage samples shown in Table 1. Flavoring agents include those flavors known to one of ordinary skill in the art, such as natural flavors, artificial flavors, spices, seasonings, and the like. Exemplary flavoring agents include synthetic flavor oils and flavoring aromatics and/or oils, oleoresins, essences, distillates, and extracts derived from plants, leaves, flowers, fruits, and so forth, and a combination comprising at least one of the foregoing.

Exemplary flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil; useful flavoring agents include artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, prune, raisin, cola, guarana, neroli, pineapple, apricot, banana, melon, apricot, ume, cherry, raspberry, blackberry, tropical fruit, mango, mangosteen, pomegranate, papaya and so forth. Additional exemplary flavors imparted by a flavoring agent include a milk flavor, a cream flavor, a vanilla flavor; tea or coffee flavors, such as a green tea flavor, an oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamon flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; a nut flavor such as an almond flavor, a hazelnut flavor, a macadamia nut flavor, a peanut flavor, a pecan flavor, a pistachio flavor, and a walnut flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor.

In some embodiments, other flavoring agents include aldehydes and esters such as cinnamyl acetate, cinnamaldehyde, citral diethylacetal, dihydrocarvyl acetate, eugenyl formate, p-methylamisol, and so forth. Further examples of aldehyde flavorings include acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), and the like. Generally any flavoring or food additive such as those described in Chemicals Used in Food Processing, publication 1274, pages 63-258, by the National Academy of Sciences, can be used. This publication is incorporated herein by reference.

In some embodiments, the composition may include optional additives such as antioxidants, amino acids, caffeine, coloring agents (“colorants”, “colorings”), emulsifiers, flavor potentiators, food-grade acids, minerals, micronutrients, plant extracts, phytochemicals (“phytonutrients”), preservatives, salts including buffering salts, stabilizers, thickening agents, medicaments, vitamins, and a combination comprising at least one of the foregoing additives. Those of ordinary skill in the art will appreciate that certain additives may meet the definition or function according to more than one of the above-listed additive categories.

The pH of beverages may also be modified by the addition of food-grade compounds such as ammonium hydroxide, sodium carbonate, potassium carbonate, sodium bicarbonate, and the like, and a combination comprising at least one of the foregoing. Additionally, the pH of the beverage can be adjusted by the addition of carbon dioxide.

Evaluation of those samples indicated in Table 1 was performed using consumer testing and evaluation by a trained sensory panel. All samples were served blind and identified with a three digit numerical code. Four ounces of chilled product was poured from the package into eight-ounce cups. Participants did not see or view the package in these tests. Participants completed a questionnaire for each product. All products were served following a modified balanced block design to minimize testing bias. A total of 216 consumers were used for the product testing experiments.

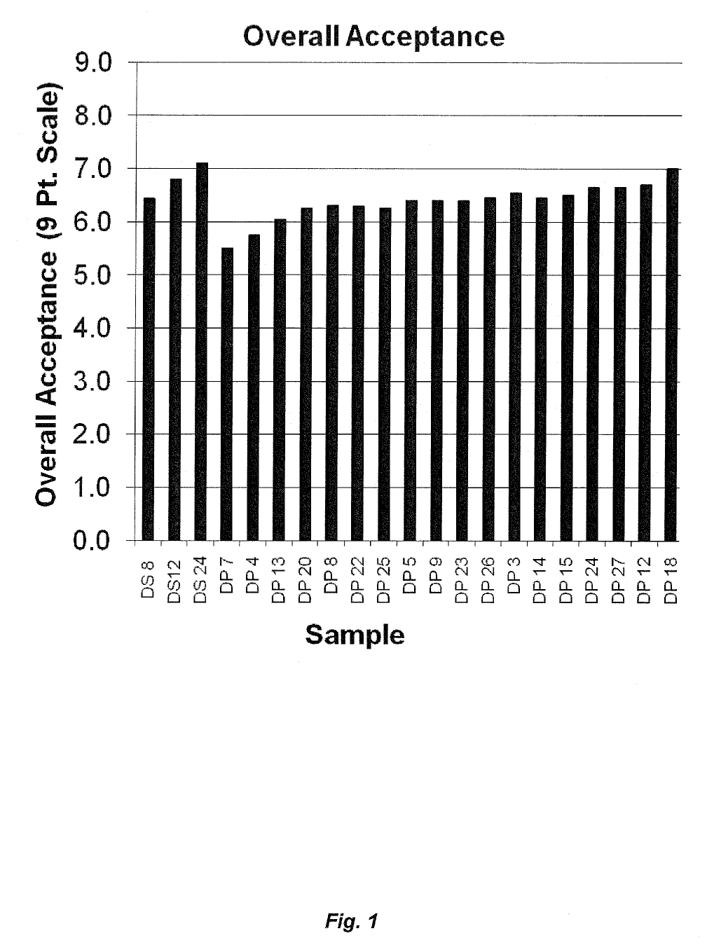

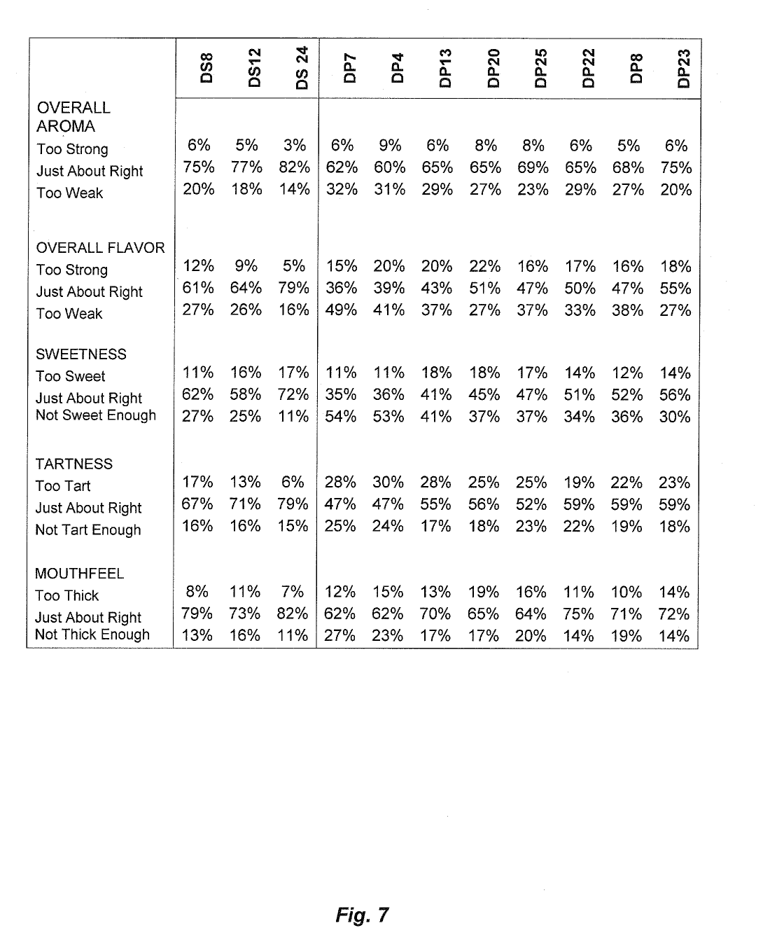

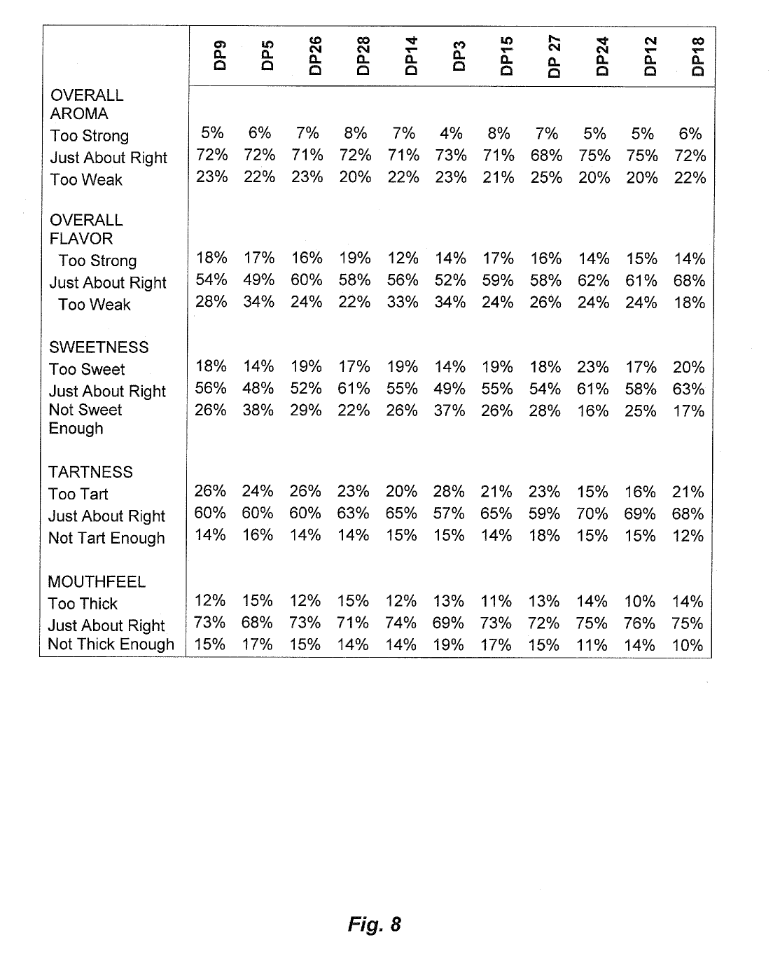

In the questionnaire panelists were asked to evaluate characteristics of the consumable items including but not limited to overall acceptance, overall flavor, sweetness, aroma, tartness, smoothness, carbonation, aftertaste, aftertaste quality and mouthfeel. Several of these characteristics were ranked on a 9-point scale, with higher values corresponding to an improvement in the characteristic. The results of this ranking for overall acceptance, overall flavor, sweetness, smoothness, aftertaste, and aftertaste quality are included in FIGS. 1-6. In addition to ranking on the 9-point scale, characteristics including the overall aroma, overall flavor, sweetness, tartness, and mouthfeel were evaluated by having the panelist mark whether the characteristic was just about right, too high, or too low. FIGS. 7 and 8 include data for the percentage of panelists who described the characteristic in each of those three categories.

Data in Table 1 and FIG. 1 indicate that, in some embodiments, the natural sweeteners fructose or stevia extract may be used with the high potency sweeteners aspartame and acesulfame potassium to improve the overall acceptance of consumable items. Other embodiments included in FIG. 1 may use a combination of fructose and stevia extract with the high potency sweeteners aspartame and acesulfame potassium. Those embodiments may also improve the overall acceptance of a reduced calorie consumable item.

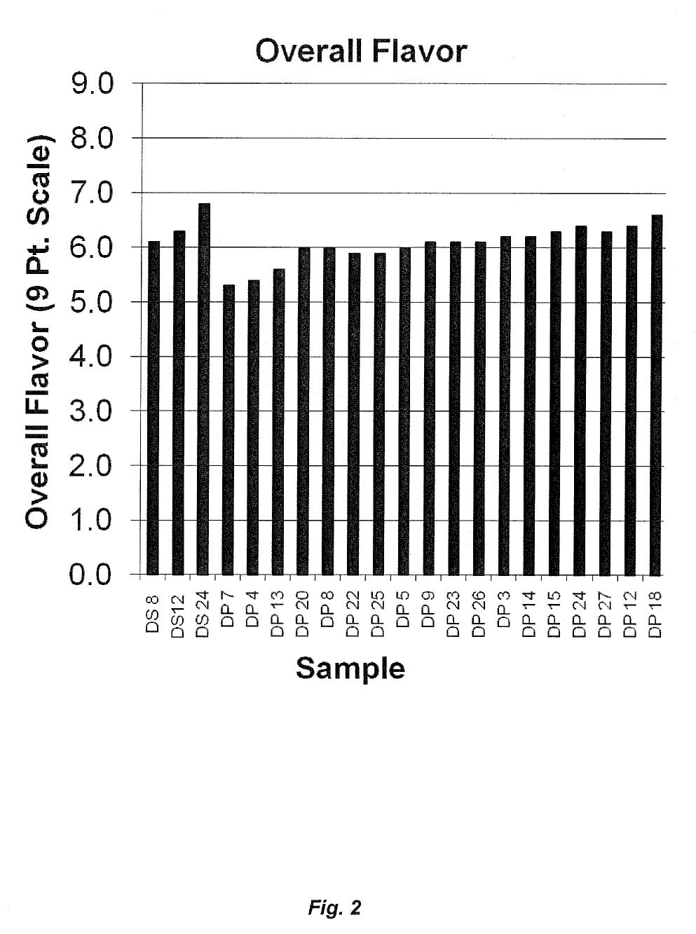

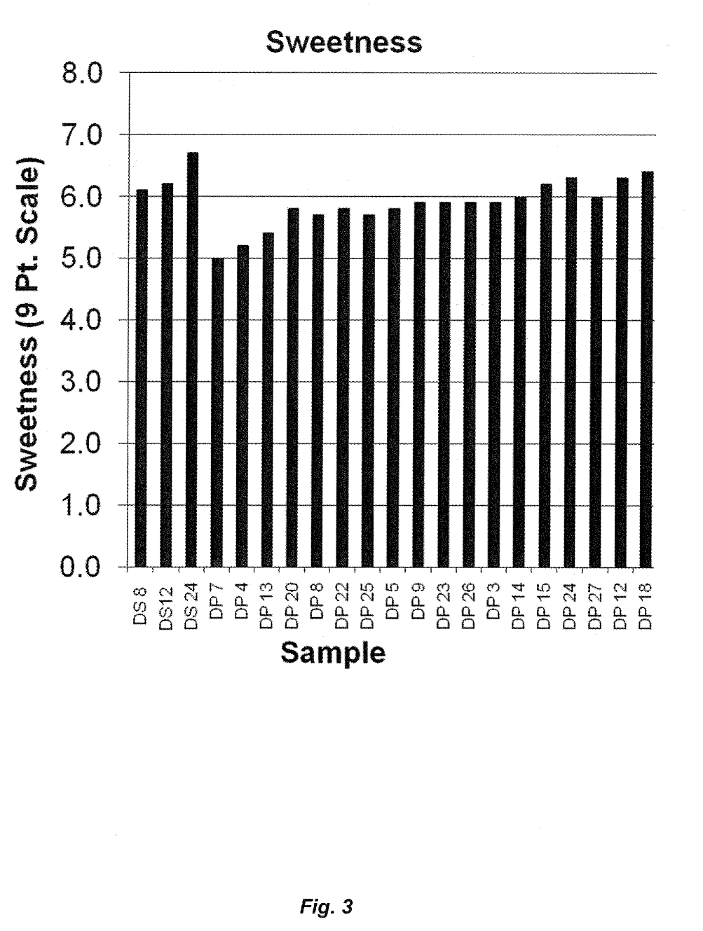

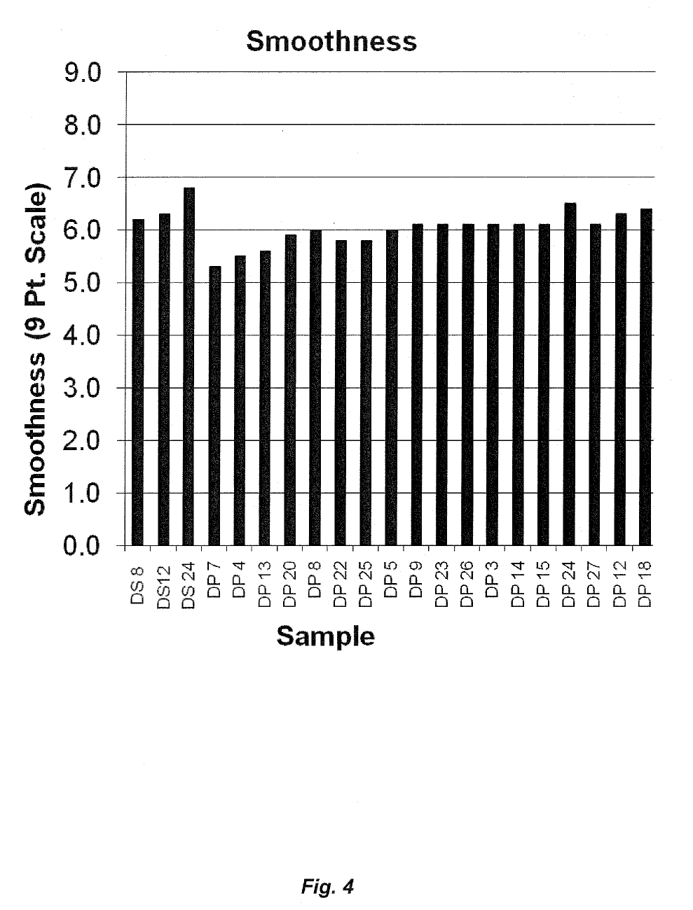

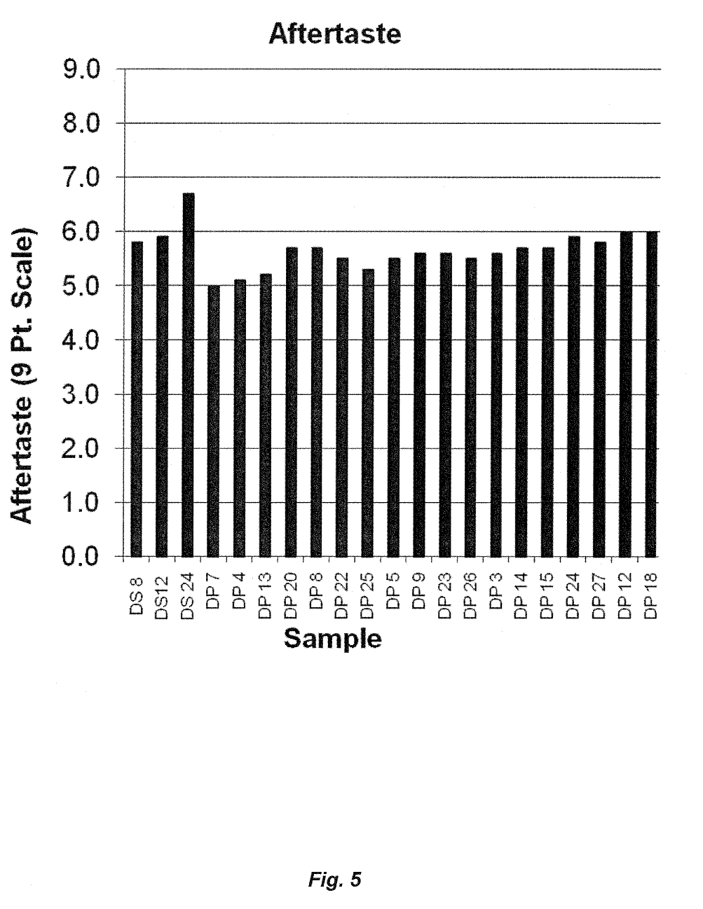

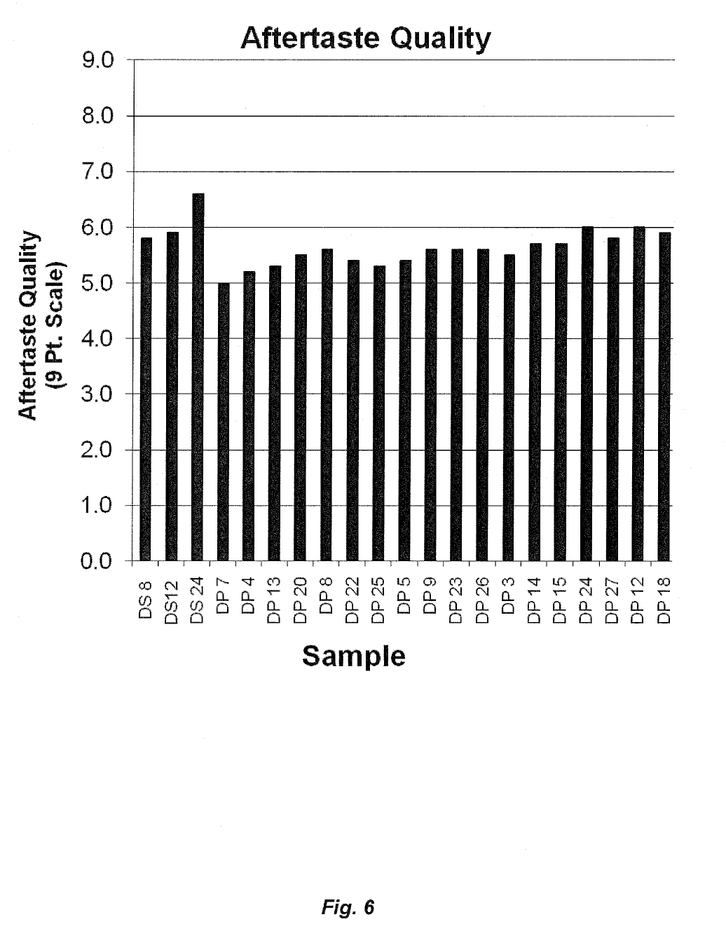

Comparison of sample DP 25 and sample DP 12 may, for example, be used to illustrate some effects of adding fructose to a combination of high potency sweeteners including aspartame and acesulfame potassium. Sample DP 25 was prepared by addition of sweeteners including 252 ppm aspartame and 60 ppm acesulfame potassium; neither stevia extract nor fructose was added to sample DP 25. Sample DP 12 was prepared using the same ingredients, at the same concentrations, with the exception that fructose was added to a final concentration of about 5×10³ ppm. As indicated in FIG. 1, the overall acceptance of sample DP 12 (6.7) is significantly improved over that of sample DP 25 (6.3). This difference is significant when evaluated based on criteria established for a confidence interval of 95%. As shown in FIG. 3, with the addition of fructose between those two samples, the average sweetness ranking from the evaluation is improved from a value of 5.7 to a value of 6.3. In some embodiments, this increased ranking may reflect improvements in the magnitude of sweetness perception, the sweetness temporal profile, the sweetness spatial profile, or a combination thereof. Such improvements may influence various characteristics as described herein. More specifically, additional characteristics including but not limited to smoothness (FIG. 4), mouthfeel (FIGS. 7 and 8), tartness (FIGS. 7 and 8) and flavor (FIG. 2) were significantly improved by the addition of fructose. It is furthermore evident, from FIGS. 5 and 6, that the aftertaste and aftertaste quality are improved by the addition of fructose. Table 2 shows a summary of data using the 9-point ranking in FIGS. 1-6 that are specific to the comparison of samples DP 12 and DP 25

TABLE 2
Some Characteristics of adding Fructose to a Consumable
Item - Comparison of Samples DP 12 and DP 25

| | DP 12 | DP 25 |
|---|---|---|
| Property | (Contains 7 KCal Fructose) | (No Added Fructose) |
| Overall Acceptance | 6.7 | 6.3 |
| Overall Flavor | 6.4 | 5.9 |
| Sweetness | 6.3 | 5.7 |
| Smoothness | 6.3 | 5.8 |
| Aftertaste | 6.0 | 5.3 |
| Aftertaste Quality | 6.0 | 5.3 |

As indicated in FIGS. 7 and 8, the percentage of panelists that described the mouthfeel of sample DP 12 to be just about right is 76%, which is significantly greater than that of sample DP 25 (64%). FIGS. 7 and 8 indicate a greater proportion of individuals ranked the sweetness and tartness to be just about right for sample DP 12. The balance of sweetness to tartness was significantly improved in sample DP 12 as compared to sample DP 25. The level of fructose added to sample DP 12 is sufficient to provide only about 7 Kilocalories to the consumable item. The sweetness provided by this level of fructose may be insufficient by itself to produce a consumable with a desired level of sweetness, or acceptable taste. However, the small amount of fructose added to the combination of the high potency sweeteners aspartame and acesulfame potassium may increase the sweetness to a desired level and significantly improve the overall acceptance of the consumable and specific characteristics including several that are frequently lacking in low calorie consumable items.

The improvement in sweetness for sample DP 12 as compared to DP 25 may be considered in respect to the corresponding improvements in flavor, mouthfeel and smoothness. The improvement in the combination of those properties is consistent with a model wherein delocalization of sweetness perception is present. The improvement in sweetness ranking in combination with improvements in flavor is consistent with a model wherein the temporal sweetness profile is more similar to that of natural sugars. This result is also supported by the improved balance of sweetness to tartness in sample DP 12.

The addition of stevia extract to a combination of aspartame and acesulfame potassium results in an improvement in the overall acceptance for most of the samples in Table 1. As shown in the data of FIG. 1, the low calorie samples that include a 25 ppm concentration of stevia extract have an average overall acceptance of 6.45, a value that compares favorably to samples without stevia extract (6.24). Individual characteristics shown in FIGS. 2-8, including but not limited to overall flavor, sweetness, aftertaste, smoothness and mouthfeel, are also improved in these samples.

Several of the samples described in Table 1 include, in addition to the high potency sweeteners aspartame and acesulfame potassium, a combination of fructose and stevia extract. In some embodiments the combination of the natural sweeteners fructose and stevia extract significantly improves the taste characteristics of a consumable item. Sample DP 18, for example, includes about 5×10³ ppm fructose, about 25 ppm stevia, and has a calorie content of only about 10 Kilocalories. The level of sweetness provided by these natural sweeteners, at these concentrations, may not, without other components, be sufficient to produce a consumable item with acceptable taste characteristics, including for example sweetness. However, when used with the high potency sweeteners aspartame and acesulfame potassium, the combination of stevia extract and fructose may produce a consumable item with acceptable sweetness, and which suppresses many of the negative attributes commonly associated with other low calorie consumables. As indicated in FIG. 3, the sweetness ranking of sample DP 18 is 6.4, significantly better than that of the reference diet sample DP 27, which has a value of 6.0. All of the characteristics included in FIGS. 1-8 are improved for sample DP 18, when compared to the diet reference sample DP 27. The improvement of those characteristics supports a model wherein both the temporal profile of sweetness and the spatial distribution of sweetness perception are improved. Table 3 shows a summary of the 9-point ranking data included in FIGS. 1-6 that is specific to the comparison of sample DP 18 and the reference samples DS 24 and DP 27.

TABLE 3
Some Characteristics of Adding a Combination of Natural
Sweeteners to a Consumable - Comparison of Samples
DP 18, DS 24 and DP 27

| | DP 18 (natural and high | DS 24 | DP 27 |
|---|---|---|---|
| | potency sweetener | reference | reference |
| Property | combination) | (full calorie) | (diet) |
| Overall Acceptance | 7.0 | 7.1 | 6.6 |
| Overall Flavor | 6.6 | 6.8 | 6.3 |
| Sweetness | 6.4 | 6.7 | 6.0 |
| Smoothness | 6.4 | 6.8 | 6.1 |
| Aftertaste | 6.0 | 6.7 | 5.8 |
| Aftertaste Quality | 5.9 | 6.6 | 5.8 |

In addition to the data in the 9-point ranking, as shown in FIG. 8 the percentage of panelists describing aroma, overall flavor, sweetness, tartness, and mouthfeel in the “just about right” category is improved for sample DP 18 in comparison to the diet reference sample DP 27. For example, the improvement in the percentage of panelists describing the overall flavor, sweetness and tartness in the optimum category is at least 9%.

About an ideal level of sweetness was achieved in this reduced calorie consumable, and when compared to low calorie consumables using other sweeteners this blend manages to provide more sugar-like characteristics such as smoothness, mouthfeel, and an increase in overall flavor. Those characteristics support a model where the combination of fructose and stevia triggers sweetness receptors throughout the oral cavity and contributes to delocalization of sweetness perception. As described above, delocalization of sweetness perception is an attribute that frequently drives preference with consumers and contributes to the high overall acceptance of consumables in some embodiments. In addition, the combination of improvements in overall sweetness, flavor and the balance of sweetness to tartness support a model wherein the temporal profile of sweetness is more similar to that of natural sugar. The simultaneous improvement in both the temporal and spatial profile of sweetness of sample DP 18, and the suppression of negative characteristics commonly associated with other low calorie consumables, is evidence of strong synergy between fructose, aspartame, acesulfame potassium and stevia extract. In some embodiments, it may not be possible to simultaneously match both the temporal profile and the spatial profile of natural sugars using high potency sweeteners alone. For example, sample DP 25 includes only the high potency sweeteners aspartame and acesulfame potassium, and has an overall acceptance of 6.3. Sample DP 12 includes fructose along with those high potency sweeteners and has significantly improved overall acceptance (6.7). Sample DP 18 includes both fructose and stevia along with those high potency sweeteners and has an even still greater overall acceptance (7.0). The overall acceptance of sample DP 12 (6.7), a sample that includes those high potency sweeteners with fructose, has been described above. The addition of both fructose and stevia with the high potency sweeteners aspartame and acesulfame potassium provides even greater flexibility in optimization of sweetener properties and significant improvement in overall acceptance and the suppression of negative characteristics. Despite having a calorie content of only about 10 Kilocalories, sample DP 18 has an overall acceptance (7.0) similar to that of a full calorie consumable such as DS 24 (7.1), which has a much higher calorie content of about 150 Kilocalories.

While many examples in this document refer to consumable items with reduced calorie sweeteners, it is understood that consumable items with reduced calorie sweeteners are described in an exemplary manner only and that other consumable items with reduced calorie sweeteners may be used. Additionally, other ingredients may be used, depending on the particular needs. Although the foregoing specific details describe certain embodiments, persons of ordinary skill in the art will recognize that various changes may be made in the details of these embodiments without departing from the spirit and scope of this invention as defined in the appended claims and considering the doctrine of equivalents. Therefore, it should be understood that this invention is not limited to the specific details shown and described herein.

What is claimed is:

1. A beverage comprising:
aspartame at a concentration of about 1 ppm to about 400 ppm;
acesulfame potassium at a concentration of about 1 ppm to about 150 ppm; and
a natural sweetener selected from the group of fructose, stevia extract and a combination thereof.

2. The beverage of claim 1 wherein said natural sweetener comprises fructose in a concentration from about 1,000 ppm to about 92,000 ppm.

3. The beverage of claim 1 where said natural sweetener comprises fructose in a concentration from about 3,000 ppm to about 20,000 ppm.

4. The beverage of claim 1 wherein said natural sweetener comprises stevia extract in a concentration from about 10 ppm to about 150 ppm.

5. The beverage of claim 1 wherein said natural sweetener comprises stevia extract in a concentration from about 20 ppm to about 120 ppm.

6. The beverage of claim 1 wherein said natural sweetener comprises fructose in a concentration from about 1,000 ppm to about 92,000 ppm and stevia extract in a concentration from about 10 ppm to about 150 ppm.

7. The beverage of claim 1 wherein said natural sweetener comprises fructose in a concentration from about 3,000 ppm to about 20,000 ppm and stevia extract in a concentration from about 20 ppm to about 120 ppm.

8. The beverage of claim 1 wherein said natural sweetener comprises fructose in a concentration from about 1,000 ppm to about 92,000 ppm and stevia extract in a concentration from about 20 ppm to about 120 ppm.

9. The beverage of claim 1 wherein said natural sweetener comprises fructose in a concentration from about 3,000 ppm to about 20,000 ppm and stevia extract in a concentration from about 10 ppm to about 150 ppm.

10. The beverage of claim 1 wherein said beverage is a reduced calorie beverage.

11. A beverage comprising:
aspartame at a concentration of about 100 ppm to about 260 ppm;
acesulfame potassium at a concentration of about 50 ppm to about 100 ppm; and
a natural sweetener selected from the group of fructose, stevia extract and a combination thereof.

12. The beverage of claim 11 wherein said natural sweetener comprises fructose in a concentration from about 1,000 ppm to about 92,000 ppm.

13. The beverage of claim 11 wherein said natural sweetener comprises fructose in a concentration from about 3,000 ppm to about 20,000 ppm.

14. The beverage of claim 11 wherein said natural sweetener comprises stevia extract in a concentration from about 10 ppm to about 150 ppm.

15. The beverage of claim 11 wherein said natural sweetener comprises stevia extract in a concentration from about 20 ppm to about 120 ppm.

16. The beverage of claim 11 wherein said natural sweetener comprises fructose in a concentration from about 1,000 ppm to about 92,000 ppm and stevia extract in a concentration from about 10 ppm to about 150 ppm.

17. The beverage of claim 11 wherein said natural sweetener comprises fructose in a concentration from about 3,000 ppm to about 20,000 ppm and stevia extract in a concentration from about 20 ppm to about 120 ppm.

18. The beverage of claim 11 wherein said natural sweetener comprises fructose in a concentration from about 1,000 ppm to about 92,000 ppm and stevia extract in a concentration from about 20 ppm to about 120 ppm.

19. The beverage of claim 11 wherein said natural sweetener comprises fructose in a concentration from about 3,000 ppm to about 20,000 ppm and stevia extract in a concentration from about 10 ppm to about 150 ppm.

20. The beverage of claim 11 wherein said beverage is a reduced calorie beverage.

21. A beverage comprising:
aspartame at a concentration of about 100 ppm to about 260 ppm;
acesulfame potassium at a concentration of about 50 ppm to about 100 ppm;
said aspartame and said acesulfame potassium included at a ratio of aspartame:acesulfame potassium between about 3:1 to about 5:1; and
a natural sweetener selected from the group of fructose, stevia extract and a combination thereof.

22. The beverage of claim 21 wherein said natural sweetener comprises fructose in a concentration from about 1,000 ppm to about 92,000 ppm.

23. The beverage of claim 21 wherein said natural sweetener comprises fructose in a concentration from about 3,000 ppm to about 20,000 ppm.

24. The beverage of claim 21 wherein said natural sweetener comprises stevia extract in a concentration from about 10 ppm to about 150 ppm.

25. The beverage of claim 21 wherein said natural sweetener comprises stevia extract in a concentration from about 20 ppm to about 120 ppm.

26. The beverage of claim 21 wherein said natural sweetener comprises fructose in a concentration from about 1,000 ppm to about 92,000 ppm and stevia extract in a concentration from about 10 ppm to about 150 ppm.

27. The beverage of claim 21 wherein said natural sweetener comprises fructose in a concentration from about 3,000 ppm to about 20,000 ppm and stevia extract in a concentration from about 20 ppm to about 120 ppm.

28. The beverage of claim 21 wherein said natural sweetener comprises fructose in a concentration from about 1,000 ppm to about 92,000 ppm and stevia extract in a concentration from about 20 ppm to about 120 ppm.

29. The beverage of claim 21 wherein said natural sweetener comprises fructose in a concentration from about 3,000 ppm to about 20,000 ppm and stevia extract in a concentration from about 10 ppm to about 150 ppm.

30. The beverage of claim 21 wherein said beverage is a reduced calorie beverage.

31. A beverage comprising:
aspartame at a concentration of about 250 ppm;
acesulfame potassium at a concentration of about 60 ppm; and
a natural sweetener comprising fructose in a concentration of about 5,200 ppm and stevia extract in a concentration of about 25 ppm.

32. The beverage of claim 31 wherein said beverage is a reduced calorie beverage.

33. A consumable item comprising:
aspartame at a concentration of about 1 ppm to about 400 ppm;
acesulfame potassium at a concentration of about 1 ppm to about 150 ppm; and
a natural sweetener selected from the group of fructose, stevia extract and a combination thereof.

34. The consumable item of claim 33 wherein said natural sweetener comprises fructose in a concentration from about 1,000 ppm to about 92,000 ppm.

35. The consumable item of claim 33 where said natural sweetener comprises fructose in a concentration from about 3,000 ppm to about 20,000 ppm.

36. The consumable item of claim 33 wherein said natural sweetener comprises stevia extract in a concentration from about 10 ppm to about 150 ppm.

37. The consumable item of claim 33 wherein said natural sweetener comprises stevia extract in a concentration from about 20 ppm to about 120 ppm.

38. The consumable item of claim 33 wherein said natural sweetener comprises fructose in a concentration from about 1,000 ppm to about 92,000 ppm and stevia extract in a concentration from about 10 ppm to about 150 ppm.

39. The consumable item of claim 33 wherein said natural sweetener comprises fructose in a concentration from about 3,000 ppm to about 20,000 ppm and stevia extract in a concentration from about 20 ppm to about 120 ppm.

40. The consumable item of claim 33 wherein said natural sweetener comprises fructose in a concentration from about 1,000 ppm to about 92,000 ppm and stevia extract in a concentration from about 20 ppm to about 120 ppm.

41. The consumable item of claim 33 wherein said natural sweetener comprises fructose in a concentration from about 3,000 ppm to about 20,000 ppm and stevia extract in a concentration from about 10 ppm to about 150 ppm.

42. A consumable item comprising:
aspartame at a concentration of about 250 ppm;
acesulfame potassium at a concentration of about 60 ppm;
a natural sweetener comprising fructose in a concentration of about 5,200 ppm and stevia extract in a concentration of about 25 ppm.

43. A sweetener comprising:
aspartame, acesulfame potassium, fructose, and stevia extract;
said aspartame and said acesulfame potassium included at a ratio of aspartame:acesulfame potassium between about 0.8:1 to about 8:1;
said aspartame and said fructose included at a ratio of aspartame:fructose between about 0.001:1 to about 0.4:1; and
said aspartame and said stevia extract included at a ratio of aspartame:stevia extract between about 0.67:1 to about 4:1.

44. The sweetener of claim 43 wherein said sweetener comprises a powder.

45. A sweetener comprising:
aspartame, acesulfame potassium, and fructose;
said aspartame and said acesulfame potassium included at a ratio of aspartame:acesulfame potassium between about 0.8:1 to about 8:1; and
said aspartame and said fructose included at a ratio of aspartame:fructose between about 0.001:1 to about 0.4:1.

46. The sweetener of claim 45 wherein said sweetener comprises a powder.

47. A sweetener comprising:
aspartame, acesulfame potassium, and stevia extract;
said aspartame and said acesulfame potassium included at a ratio of aspartame:acesulfame potassium between about 0.8:1 to about 8:1; and
said aspartame and said stevia extract included at a ratio of aspartame:stevia extract between about 0.67:1 to about 4:1.

48. The sweetener of claim 47 wherein said sweetener comprises a powder.
